(19) United States
(12) Patent Application Publication
(10) Pub. No.: US 2016/0300164 A1
(43) Pub. Date: Oct. 13, 2016

(54) User Interface for Travel Assistant and Method Therefor

(71) Applicant: Mobile Travel Technologies Ltd., London (GB)

(72) Inventors: Paul Dailly, Dublin (IE); Sebastian Glowacki, Dublin (IE)

(21) Appl. No.: 15/091,832

(22) Filed: Apr. 6, 2016

(30) Foreign Application Priority Data
Apr. 7, 2015 (GB) GB1505871.2

(51) Int. Cl. G06Q 10/02; G06F 3/0481

(52) U.S. Cl. CPC G06Q 10/025; G06F 3/0481

(57) ABSTRACT

A non-transitory machine-readable medium storing a travel application which when executed by at least one processing unit of an apparatus provides notifications dependent upon the current state of a journey, the travel application comprising sets of instructions for: recording at least one journey; defining at least one state of the at least one journey; determining the current state of the at least one journey; and selecting a notification for display in a display area of a user interface of a device in dependence upon the current state of the at least one journey.

### PRIORITY

This application claims priority from United Kingdom Patent Application No. GB1505871.2 filed on Apr. 7, 2015, the entire contents of which are incorporated herein by reference.

### FIELD

The present invention relates to a user interface for a travel assistant and to a method of providing a user interface for a travel assistant more specifically, but not exclusively, to a user interface for an air travel assistant providing live travel enrichment.

### BACKGROUND

Travel between different locations may involve using one or more passenger transport systems. Most passenger transport systems typically operate to schedules specifying departure times from first locations and arrival times at second locations. The transport systems may employ any number of different modes of transport such as, but not limited to, airplanes, trains, boats, buses, metros, subways and trams. Software applications exist which allow users to view the schedules and/or to book passage upon one or more transport systems in order to make a journey between a point of origin and a destination.

Making a journey on such transport systems can be stressful. The passenger must be mindful of a large number of factors in order to successfully complete their journey. It is an object of the present invention to reduce the stress for travellers by providing them with only the information which is pertinent to a particular stage of their journey.

Furthermore, it is desirable to provide the traveller with information regarding the current status of the transport systems which they will be utilising to make their journey.

The present invention seeks to overcome or at least mitigate the problems of the prior art.

### SUMMARY

According to a first aspect of the present invention there is provided a non-transitory machine-readable medium storing a travel application which when executed by at least one processing unit of an apparatus provides a notification dependent upon the current state of a journey, the travel application comprising sets of instructions for:

recording at least one journey;

defining at least one state of the at least one journey;

determining the current state of the at least one journey; and

selecting a notification for display in a display area of a user interface of a device in dependence upon the current state of the at least one journey.

Optionally, the set of instructions for recording at least one journey includes one or more selected from the following list:

recording data indicative of a travel itinerary;

recording a departure time;

recording a departure location;

recording an arrival time; and

recording a destination location.

Optionally, the set of instructions for defining the at least one state of the at least one journey includes:

defining at least one time-centric criteria.

Optionally, the set of instructions for defining the at least one state of the at least one journey includes:

defining at least one location-centric criteria.

Optionally, the set of instructions for defining at least one time-centric criteria comprises:

a second time-centric criteria which must be satisfied in addition to the location-centric criteria.

Optionally, the set of instructions includes:

analysing at least one data source for live travel information relevant to the current state of the journey; and

selecting a notification for display in a display area of a user interface of a device in dependence upon the current state of the at least one journey and the live travel information.

According to a second aspect of the present invention there is provided a method for providing a user interface of a travel application, the method comprising:

recording at least one journey;

defining at least one state of the at least one journey;

determining the current state of the at least one journey; and

selecting a notification for display in a display area of a user interface of a device in dependence upon the current state of the at least one journey.

Optionally, recording at least one journey comprises one or more selected from the following list:

recording data indicative of a travel itinerary;

recording a departure time;

recording a departure location;

recording an arrival time; and

recording a destination location.

Optionally, defining the at least one state of the at least one journey includes:

defining at least one time-centric criteria.

Optionally, defining the at least one state of the at least one journey includes:

defining at least one location-centric criteria.

Optionally, defining at least one time-centric criteria comprises:

a second time-centric criteria which must be satisfied in addition to the location-centric criteria.

Optionally, the method comprises:

analysing at least one data source for live travel information relevant to the current state of the journey.

According to a third aspect of the present invention there is provided a non-transitory machine-readable medium storing an air or other transport travel application which when executed by at least one processing unit of an apparatus provides a notification dependent upon the current state of a journey, the travel application comprising sets of instructions for:

recording at least one journey involving air travel;

defining a journey context comprising at least one state based upon a time-centric criteria;

determining the current state of the at least one journey by comparing the current time to the time-centric criteria; and

selecting a notification for display in a display area of a user interface of a device in dependence upon the determined current state of the at least one journey.

Optionally, the set of instructions includes:

defining a journey context comprising at least one state based upon a location-centric criteria;

receiving information characteristic of the current location of the device;

determining the current state of the at least one journey by comparing the current location of the device to the location-centric criteria.

Optionally, the set of instructions includes:

defining a journey context comprising defining one or more states selected from the following list of states:
a pre-airport state;
a landside state;
an airside state;
an inflight state;
a hotel state;
a post-flight state; and
an at gate state.

Optionally, the set of instructions includes:

receiving information characteristic of the current location of the device from one or more data sources selected from the following list of data sources:
a geolocation data source;
a positioning data source;
a global positioning system;
a satellite based positioning system;
a Bluetooth based geolocation source;
a wireless based geolocation system;
a Wi-Fi based geolocation system; and
a data entry in a software application indicating the attendance of a traveller at a predefined location on the journey.

Within the scope of this application it is envisaged that the various aspects, embodiments, examples, features and alternatives set out in the preceding paragraphs, in the claims and/or in the following description and drawings may be taken independently or in any combination thereof. For example, features described in connection with one embodiment are applicable to all embodiments unless there is incompatibility of features.

### BRIEF DESCRIPTION OF THE DRAWINGS

Exemplary embodiments of the invention will now be described with reference to the accompanying drawings, in which:

FIG. 1 is a schematic view of a system for providing a travel application according an embodiment of the invention;

FIG. 2 is a schematic view of a system for providing a travel application according an embodiment of the invention;

FIG. 3 is a schematic view of a component of the system illustrated in FIG. 2;

FIGS. 4 to 10 conceptually illustrate journey states of the travel application according embodiments of the invention;

FIGS. 11 to 14 conceptually illustrate display areas of the travel application associated with a first journey state;

FIGS. 15 to 16 conceptually illustrate display areas of the travel application associated with a second journey state;

FIG. 17 conceptually illustrates display areas of the travel application associated with a third journey state;

FIG. 18 conceptually illustrates display areas of the travel application associated with a fourth journey state;

FIGS. 19 and 20 conceptually illustrate display areas of the travel application associated with a fifth journey state;

FIG. 21 conceptually illustrates display areas of the travel application associated with a sixth journey state; and

FIG. 22 conceptually illustrates display areas of the travel application associated with a seventh journey state.

### DETAILED DESCRIPTION

Detailed descriptions of specific embodiments of the system, method and user interface are disclosed herein. It will be understood that the disclosed embodiments are merely examples of the way in which certain aspects of the invention can be implemented and do not represent an exhaustive list of all of the ways the invention may be embodied. Indeed, it will be understood that the system, method and user interface described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

Some of the embodiments of the invention provide a novel travel application that provides several features for facilitating making a journey on one or more transport systems. In some embodiments the travel application provides a novel user interface that provides a user with contextual information at each stage of their journey. In this way the user will not be provided with irrelevant information. In some embodiments the travel application provides a novel user interface that provides a user with a display area comprising that information which is pertinent to a particular stage of their journey. In some embodiments the travel application provides a novel user interface that provides a user with live information regarding the current status of the transport systems which they will be utilising to make their journey. In some embodiments the travel application provides several user interface widgets that provide a user with notifications, alerts and/or facilitates completion of tasks associated with the journey.

In some embodiments the travel application provides a journey context software component for determining the journey state of the user. Based upon the journey state of the user the travel application can filter travel data sources and employ a user interface widget to present to the user the most pertinent travel data at any given journey state of the user.

In some embodiments the journey context software component is time-centric, the journey state of the user being based upon the current time with reference to the journey itinerary, such as the departure time and/or arrival time of any of the transport systems being employed to complete the scheduled journey.

In some embodiments the journey context software component is location-centric, the journey state of the user being based upon the current location of the user.

Some of the embodiments of the invention provide a novel air travel application that provides several features for facilitating making a journey on one or more commercial airline routes between commercial airports.

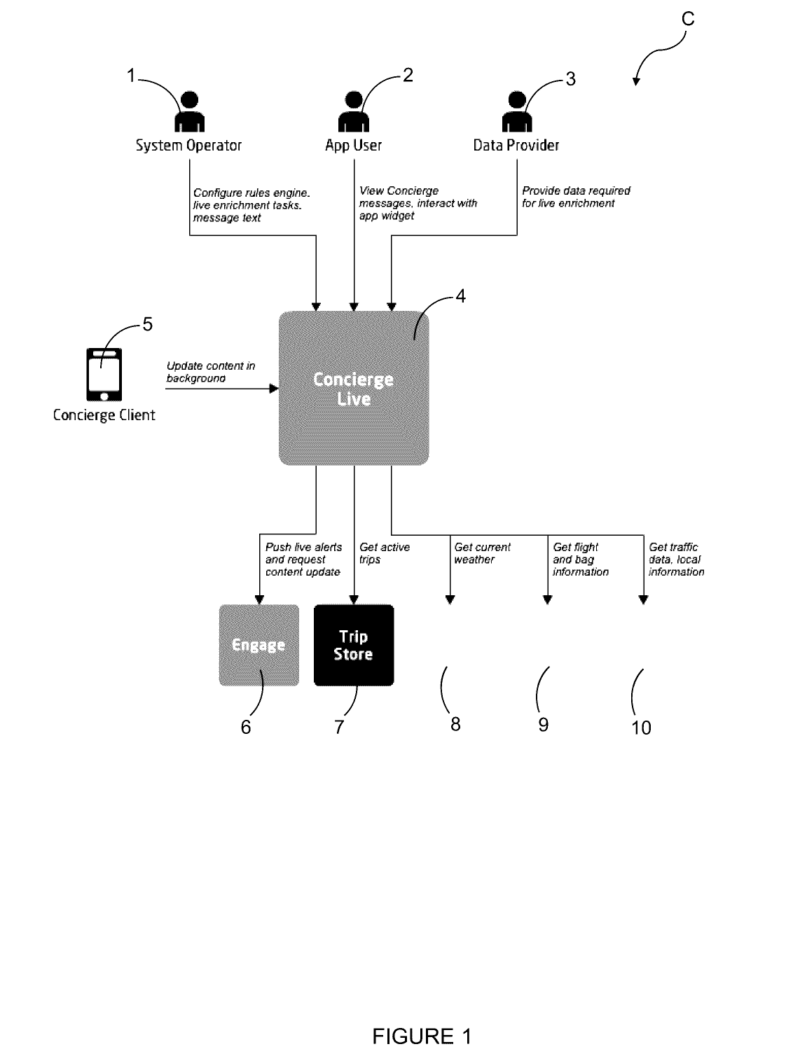

Referring to FIG. 1 there is shown a system C for providing a travel application according to an embodiment of the invention. The system C comprises a software application 4 which is stored on a non-transitory machine readable medium such as, but not limited to, a hard drive or solid-state drive. The software application is executable in at least one processing unit of a device. The device may be a server device capable of communicating with at least one client device 2, at least one system operator device 1 and with one or more data sources 3. The client device 2 may be a mobile device such as, but not limited to, a mobile telephone, smartphone, tablet, phablet, watch, glasses, netbook, laptop computer, pocket computer, handheld gaming device, music or video player, or camera. The system C comprises a client software application stored on a non-transitory machine readable medium (such as, but not limited to, flash memory, solid state drive or hard drive) of the client device.

In some embodiments at least one intermediate device may be positioned between the client device 2 and the server device.

The system C comprises a trip store 7. The trip store 7 comprises a record of at least one journey and includes the journey itinerary. The journey itinerary includes a departure time, a departure location, an arrival time and a destination location for at least one transport system or transport provider for each respective journey. The journey itinerary may also include a departure time, a departure location, an arrival time and a destination location for at least one additional transport system. The trip store 7 may be configured as one or more databases and may employ at least one database management system to allow the definition, creation, querying, update, and administration of the databases.

The system C comprises a software component 6 for sending notifications and alerts to the client device 2 and/or displaying a particular user interface with regard to the journey state.

The system C may communicate with one or more data providers 3 via software components 8, 9, 10. The software components 8, 9, 10 may be defined by, for example but not limited to, application programme interfaces (APIs). The data providers may provide data regarding, for example but not limited to: current weather in a specific location on the route of the journey; current time and date; indoor or outdoor navigation or map data; live road traffic conditions; transport system data such as, but not limited to, airport gate information, train station platform information, seaport dock information, baggage tracking, check-in queue status, baggage drop location, baggage claim location, queue status, security or border control queue status, flight status and train status.

The travel software application 4 will be described hereinafter with reference to air travel; however, in alternative embodiments the travel software application 4 may facilitate travel on alternative modes of transport. The system operator 1 may be an airline, travel agency or other third party managing travel arrangements for travellers. The system operator 1 will have access to an administration tool enabling them to customise the software application to meet their individual requirements. The travel software application 4 supports a plurality of different system operators 1.

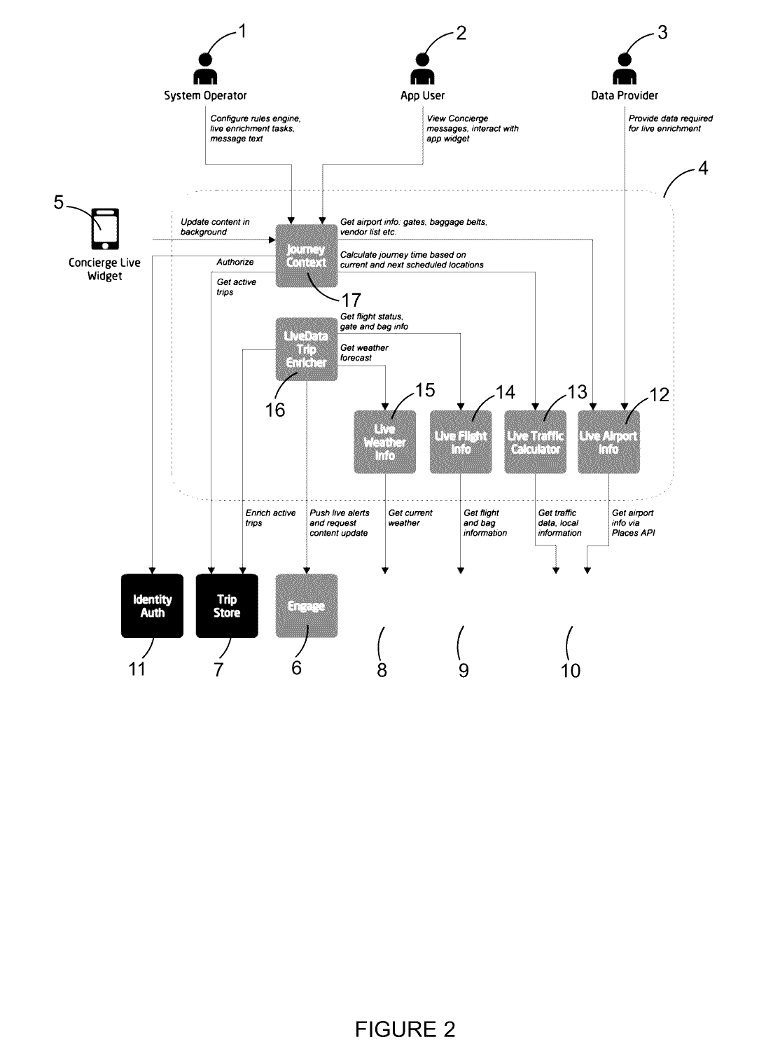

Referring now to FIG. 2, the travel software application 4 comprises a first software component 17 for defining the journey context and for determining the current state of a particular journey stored in the trip store 7.

The first software component 17 may interact with a second software component 12 which provides live transport information; for example live airport information such as check-in desk number, departure gate number and baggage claim belt number or location.

The first software component 17 may interact with a third software component 13 which provides live road traffic data.

The travel software application 4 may comprise a fourth software component 16 for enriching the travel experience of the traveller. The first software component 17 may interact with the fourth software component 16 directly or indirectly so as to only provide information relevant to the current state of the journey.

The fourth software component 16 may interact with a fifth software component 14 which provides live flight data such as information concerning delays or cancellations in scheduled flights, queue times at the check-in desk, baggage drop or security or border controls, and baggage tracking.

The fourth software component 16 may interact with a fifth software component 15 which provides live weather information concerning a specific location on the route of a given journey.

The first software component 17 may interact with an identity authorisation component 11 which creates and/or verifies a traveller's identity in order to identify their stored journeys in the trip store 7.

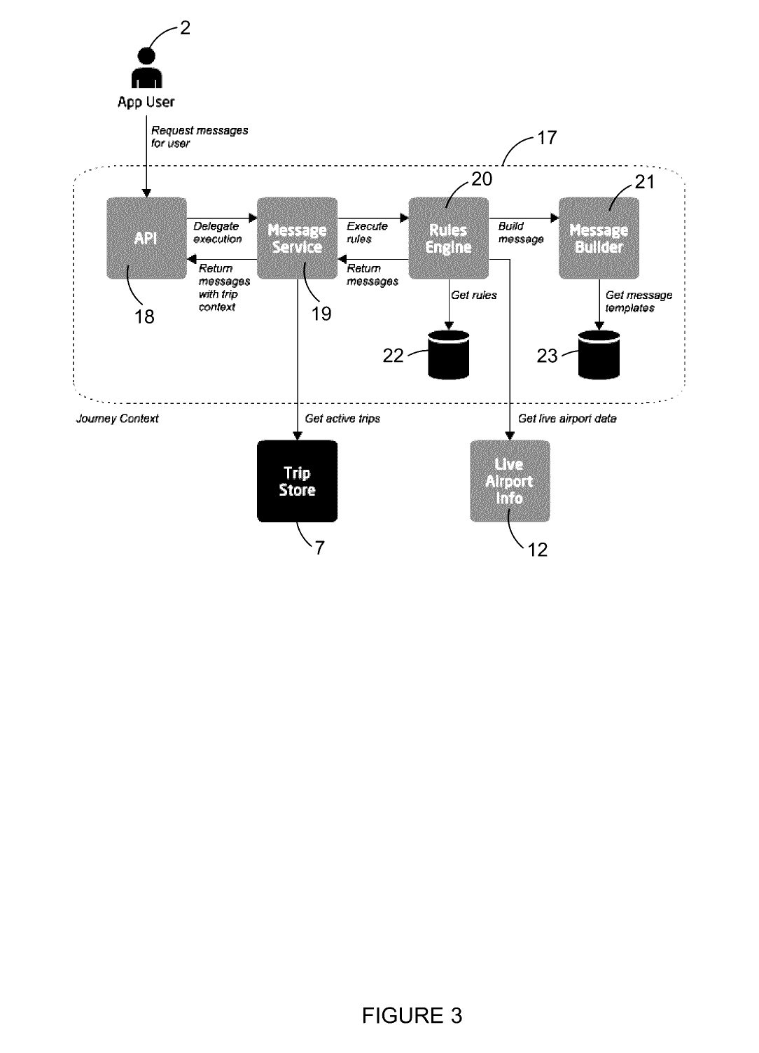

Referring now to FIG. 3, there is shown a conceptual illustration of elements of the first software component 17. The first software component 17 includes an interface 18 for interacting with the client device 2, in particular a software application installed on the client device 2. The interface 18 may also define rules, routines or protocols for interacting with software on the system operator's apparatus (not shown). The interface 18 may also allow the first software component 17 to be executed and/or added to additional software applications so as to provide its functionality to the additional software applications or to incorporate additional functionality into the first software component 17. The additional software may be executed by the server, the client device 2, the system operator's apparatus or other apparatus such as an intermediate server.

The first software component 17 includes a message service for communicating with other devices in the system such as, but not limited to, the client device 2 and the system operators apparatus.

The first software component 17 includes a database, library or list of rules 22. The list of rules 22 may be defined by the system operator or may be a predefined set of default values. The list of rules 22 may be reconfigurable or reprogrammable such that the list of rules 22 can be adapted.

The first software component 17 includes a rules engine 20. The rules engine 20 applies the list of rules 22 of a given system operator to determine the message to be sent to the client device 2. The first software component 17 includes a message builder 21 which creates the message to be sent. The message builder 21 may access a message template store 23 to find a message template about which the message is to be created.

The rules engine 20 may also interact with one or more live airport information data sources 12. The live airport information data sources 12 may provide data which is characteristic of the location of the client device 2 or of tasks completed by the traveller such as, but not limited to, having checked in, deposited bags at baggage drop, passed through security or other tasks determining a change in the journey context.

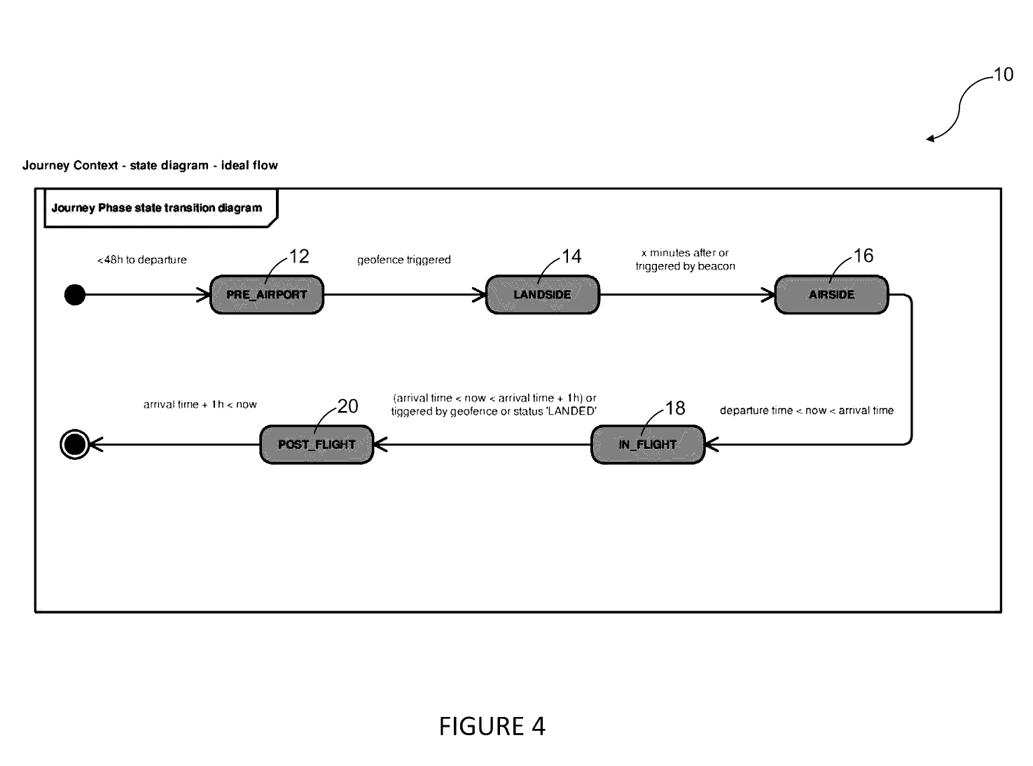

The travel software application 4 employs the rules engine 20 to determine the journey state or context. The journey state comprises predefined stages of a journey. By defining discrete journey stages, the travel software application 4 can determine the most relevant information which should be presented at a given stage. FIGS. 4 to 10 schematically illustrate various embodiments of the journey context.

One journey state is a “pre-airport” state. The travel application 4 will deliver messages to the client device 2 which are pertinent to the traveller before they reach the airport.

In one embodiment the “pre-airport” state commences a first predefined period before the time and date of departure and terminates at a second predefined period before the time and date of departure.

In another embodiment the “pre-airport” state terminates when the travel application receives data indicating the client device 2 is located in the airport. This may include data indicating that the traveller has checked-in at a check-in desk or screen, or may be derived from a location tracking system such as, but not limited to, a satellite or global positioning system (GPS), Wi-Fi based positioning system, Bluetooth based positioning system (such as iBeacons) or other wireless positioning system.

Another journey state is a landside state. This state follows the “pre-airport” state. The landside state includes the stage of the journey when the traveller reaches the airport until they enter the airside of the airport. The travel software application 4 will deliver messages to the client device 2 which are pertinent to the traveller whilst in the landside areas of the airport.

In one embodiment the landside state commences at the second predefined period before the time and date of departure and terminates at a third predefined period before the time and date of departure.

In another embodiment the landside state commences when the travel software application 4 receives data indicating the client device 2 is located in the landside of the airport and terminates when the travel software application 4 receives data indicating the client device 2 is located in the airside of the airport.

A further journey state is an airside state; this state follows the landside state. The airside state includes the stage of the journey when the traveller enters the airside of the airport until they have boarded the aircraft.

In one embodiment the airside state commences at the third predefined period before the time and date of departure and terminates at the time and date of departure.

Another optional journey state is an inflight state. The inflight state includes the stage of the journey when the traveller is on board the aircraft.

In one embodiment the inflight state commences at the time and date of departure and terminates at a first predefined period after the time and date of arrival.

In another embodiment the inflight state terminates when the travel software application 4 receives data indicating the client device 2 has landed at the destination.

A further journey state is a “post-flight” state; this state follows the inflight state. In one embodiment the “post-flight” state commences at the first predefined period after the time and date of arrival.

FIG. 4 illustrates the flow of a journey as it transitions through the predefined phases or states of a journey. The travel software application 4 provides a user interface including a display area that provides a user with contextual information at each stage of their journey. In this way the user will not be provided with irrelevant information; for example, but not limited to, the user will not be directed to baggage drop locations if they have indicated they will be carrying cabin baggage only, or to the check-in desks for their flight if they have already checked-in, and they will not be informed of facilities such as coffee shops if they do not have enough time to visit them.

When the travel software application 4 determines that a journey stored in the trip store is less than a predefined period from departure, the journey enters the pre-flight state. In the illustrated example the journey enters the pre-flight state when the travel software application 4 determines the current time is less than 48 hours before the departure time.

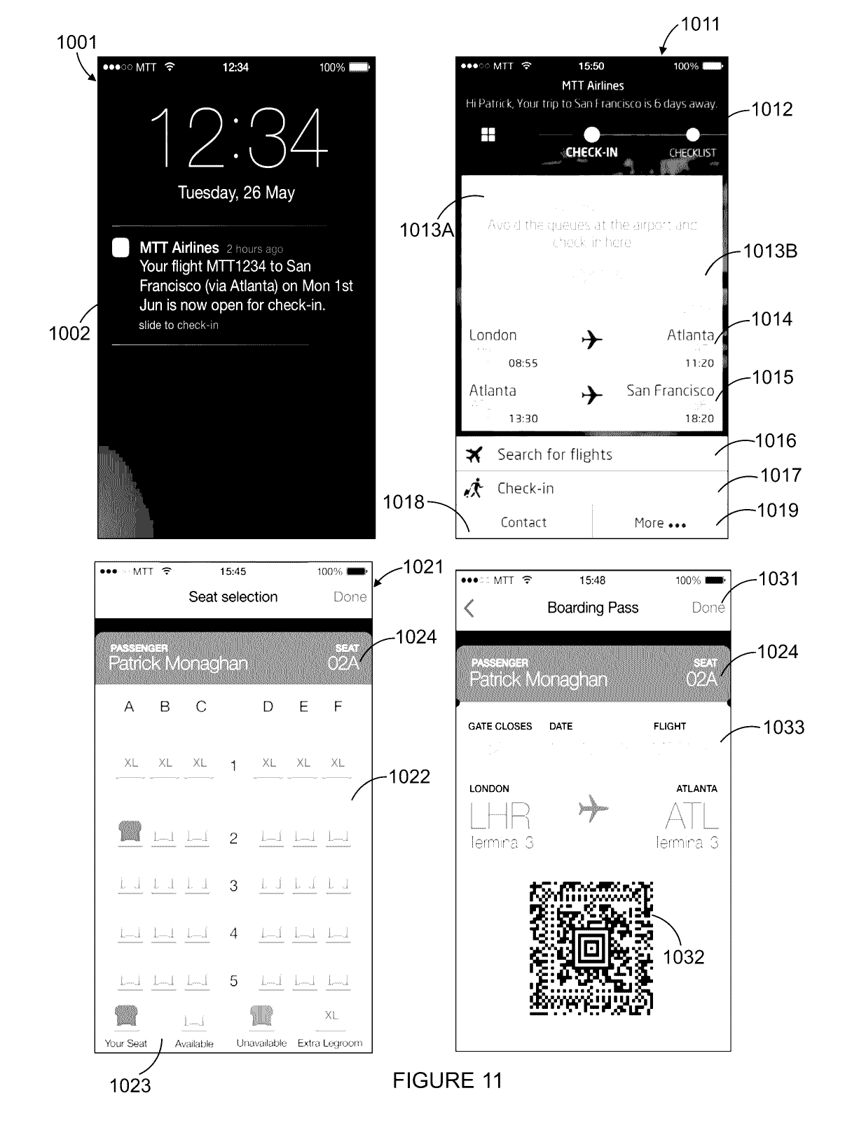

The travel software application 4 will provide the client device 2 with display interfaces which are relevant to the pre-flight state. FIGS. 11 to 14 conceptually illustrate exemplary display areas provided by the travel software application 4 which may be displayed when the journey is in the pre-flight state.

FIG. 11 shows a first graphical user interface (GUI) 1001 in which the travel software application 4 provides a display area for an alert 1002 that the user can remotely check-in for their flight. The first GUI 1001 may also provide a link or button or other input function to direct the user to a check-in software application to enable them to complete the task of checking-in. In some embodiments the travel software application 4 interacts with another separate software application so as to initiate that separate software application to send the alert to the user.

FIG. 11 shows a second graphical user interface (GUI) 1011 in which the travel software application 4 provides a display area for a notification 1013B that the user can remotely check-in for their flight. The second GUI 1011 may include a link 1013A to direct the user to the check-in software application; details of the flight 1014; details of a connecting flight 1015; a search function to search for flights 1016; an alternative link 1017 to direct the user to the check-in software application; contact functionality 1018; and a link 1019 to other functionalities of the travel software application 4. The second GUI 1011 may include a graphical control element 1012 “Breadcrumbs” or “Breadcrumb Trail” as a navigation aid for the user interfaces of the travel software application 4.

FIG. 11 shows a third graphical user interface (GUI) 1021 in which the travel software application 4 provides a display area for indicating the traveller's currently allocated seat 1024 and providing the application user with the ability to select or change their seat upon the aircraft 1022. In some embodiments the travel software application 4 interacts with another separate software application so as to initiate that separate software application to provide the user with the ability to select or change their seat upon the aircraft.

FIG. 11 shows a fourth graphical user interface (GUI) 1031 in which the travel software application 4 provides a display area for an electronic boarding pass or boarding card to facilitate airport personnel identifying that a passenger has permission to board the aircraft for a particular flight. In some embodiments the travel software application 4 interacts with another separate software application so as to initiate that separate software application to provide the user with an electronic boarding pass or boarding card. The fourth GUI 1031 may include information which identifies the passenger, the flight number, the date of departure, the gate closure time, the point of departure and destination, a bar code 1032 or other optically machine-readable representation of data shown on the boarding pass, and the scheduled time for departure (not shown in FIG. 11). In other embodiments the travel software application 4 may enable the client device 2 to interact with an alternative scanning device in the airport via, for example but not limited to, Bluetooth, Near-Field-Communication or other wireless communications protocols. The fourth graphical user interface (GUI) 1031 in which the travel software application 4 provides a display area for an electronic boarding pass may be displayed or accessed during other of the journey states, including the landside state and the airside state.

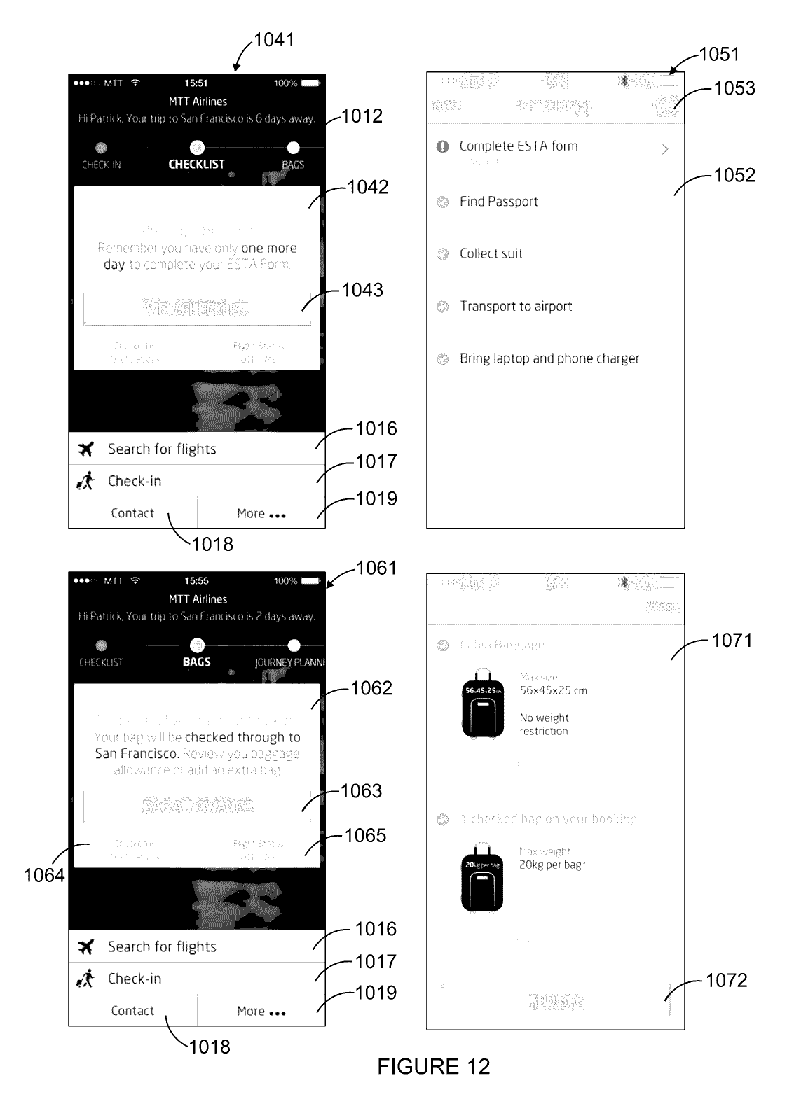

FIG. 12 shows a fifth graphical user interface (GUI) 1041 in which the travel application 4 provides a display area for a notification 1042 concerning a checklist of items or tasks required and/or desirable to make the journey. The fifth GUI may include a link 1043 to direct the user to the checklist. FIG. 12 shows a sixth graphical user interface (GUI) 1051 providing a checklist of items or tasks 1052 required and/or desirable to make the journey. The sixth GUI 1051 may include a link 1053 to add items to the checklist.

FIG. 12 shows a seventh graphical user interface (GUI) 1061 in which the travel software application 4 provides a display area for a notification 1062 concerning baggage. The notification may include information concerning “checked” baggage (those items of luggage to be transported in the hold of the aircraft, that is to say those items which will be inaccessible to the passenger during the flight or ride), cabin baggage which is permitted in the aircraft cabin with the passenger, the passenger's baggage allowance or a link to that information 1063, the flight status 1065, and a link to boarding pass 1064.

FIG. 12 shows an eighth graphical user interface (GUI) in which the travel software application 4 provides a display area 1071 showing details of the baggage allowance of the traveller, and a link 1072 or other function to enable the user to add baggage.

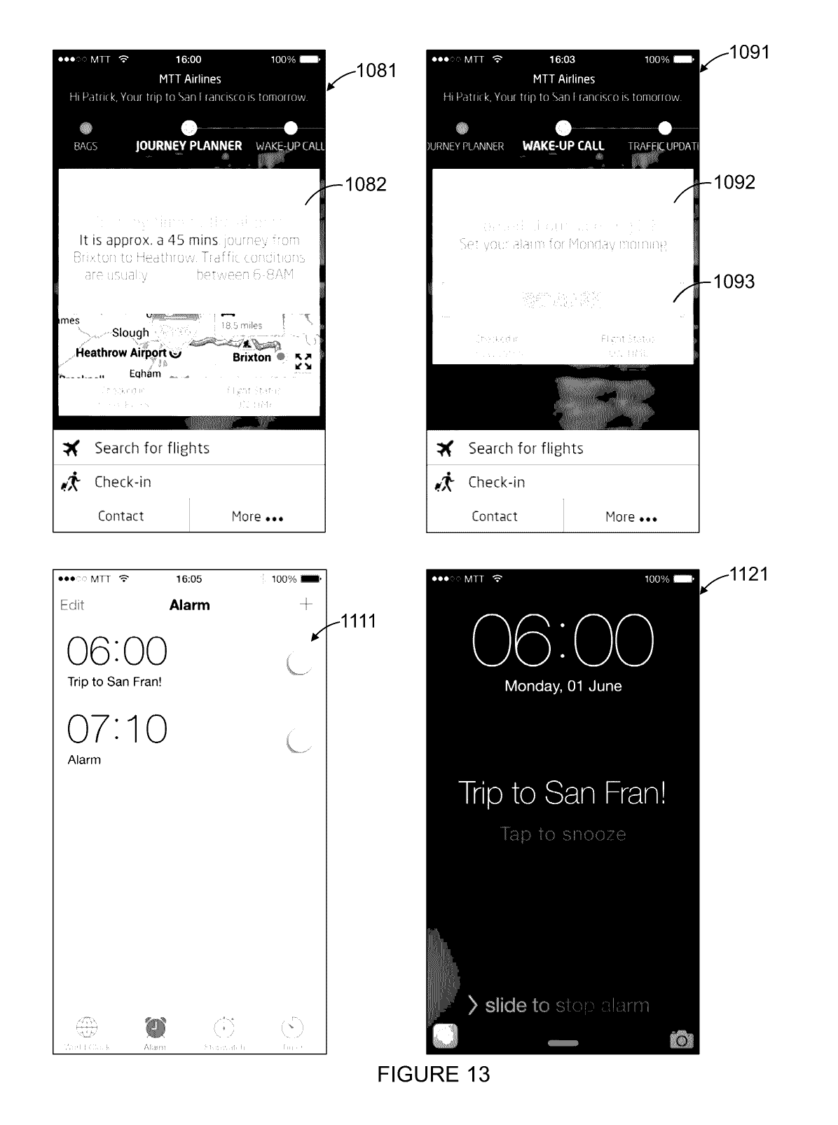

FIG. 13 shows a ninth graphical user interface (GUI) in which the travel software application 4 provides a display area 1081 for planning the traveller's route or journey to the airport. The display area 1081 may provide the traveller with an indication 1082 of the journey time to the airport from a current location of the user, a last known location of the user or a default or predefined location.

FIG. 13 shows a tenth graphical user interface (GUI) in which the travel software application 4 provides a display area 1091 including a notification 1092 for reminding the user to set a wake-up call from the client device 2. The display area 1091 may provide a link 1093 or other function to enable the user to set an alarm function.

FIG. 13 shows an eleventh graphical user interface (GUI) in which the travel software application 4 provides a display area 1111 for setting an alarm function. The travel software application 4 may link to an alarm functionality provided on the client device 2 or may provide its own dedicated alarm function.

FIG. 13 shows a twelfth graphical user interface (GUI) in which the travel software application 4 provides a display area 1121 of an alarm function so as to wake the user at the pre-set time defined by the user.

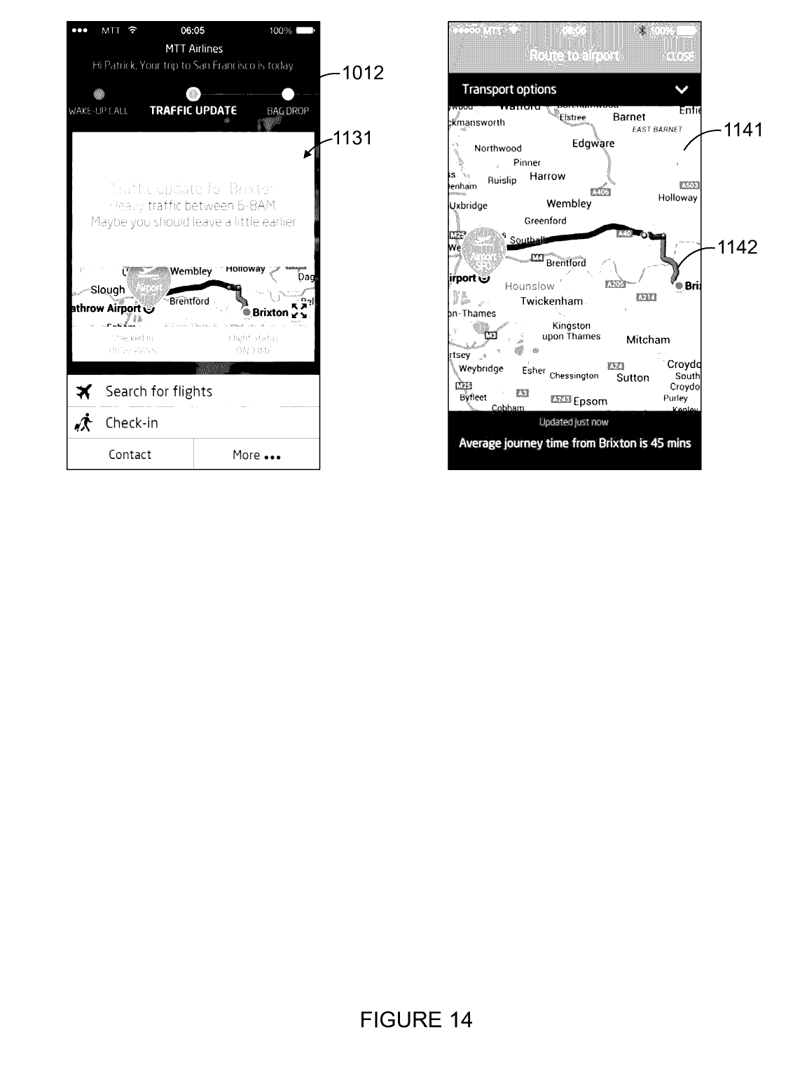

FIG. 14 shows an optional thirteenth graphical user interface (GUI) in which the travel software application 4 provides a display area 1131 including a notification of the current or live traffic conditions on a preferred, preselected, quickest or shortest route to the airport, thus informing the user that more time may be required to complete this stage of the journey than previously estimated. In this way the user can depart earlier than planned thus making allowance for the change in conditions.

FIG. 14 shows an optional fourteenth graphical user interface (GUI) in which the travel software application 4 provides a display area 1141 including a map of the current route to the airport and may also indicate a route plan 1142. The illustrated embodiment shows a road map, although in alternative embodiments the display area 1141 may provide a public transport map such as a train, subway, underground, tram, rail or bus network map.

Returning to FIG. 4, when the travel software application 4 determines that a journey stored in the trip store 7 has entered the landside state, the travel software application 4 will provide the client device 2 with display interfaces which are relevant to the landside state. In the illustrated example the journey enters the landside state when the travel software application 4 determines the client device 2 is in the airport. This may be triggered by the travel software application 4 receiving data from a geolocation system or a positioning system identifying the client device 2 as being in or at the airport.

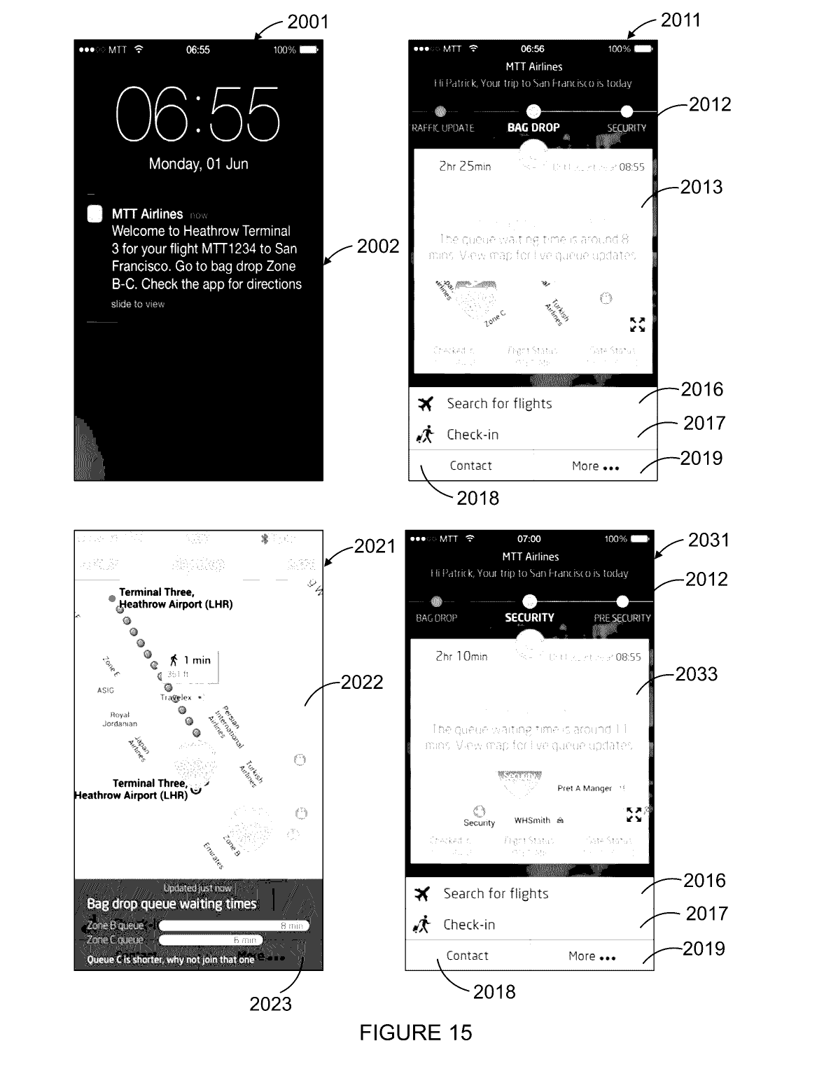

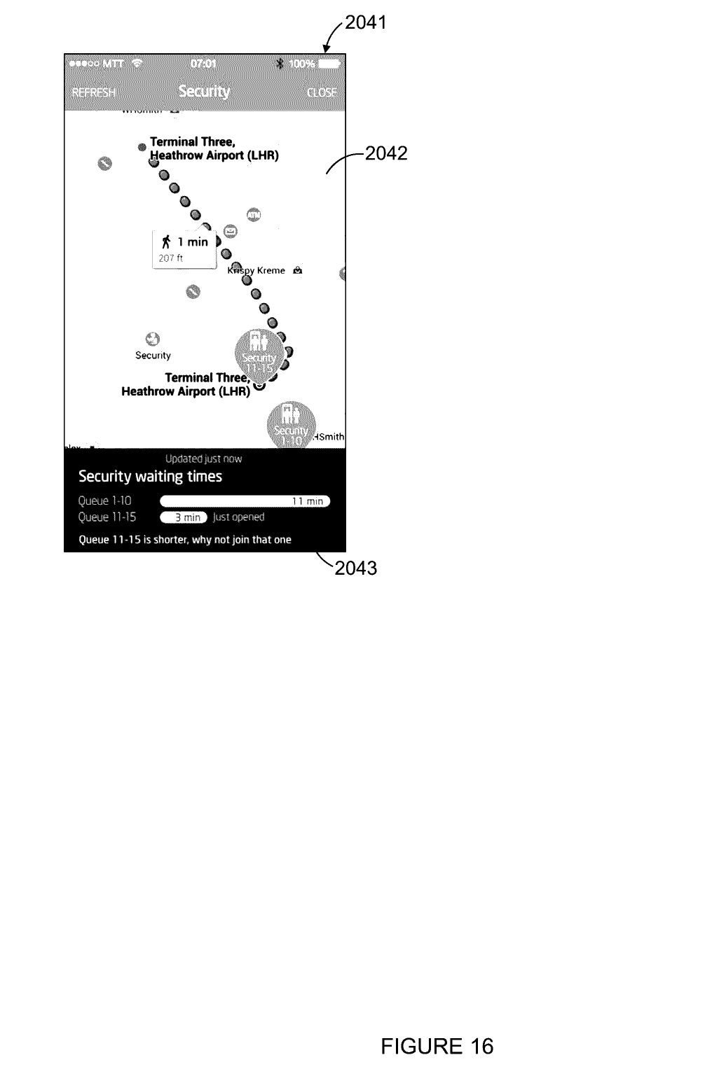

FIGS. 15 to 16 conceptually illustrate exemplary display areas provided by the travel software application 4 which may be displayed when the journey is in the landside state.

FIG. 15 shows a fifteenth graphical user interface (GUI) 2001 in which the travel software application 4 provides a display area for an alert 2002 welcoming the user to the airport and informing them of the first location in the airport to which they need to report. In the illustrated embodiment the user is directed to the relevant bag drop zone for their flight. In alternative embodiments, the travel software application 4 may identify that the user has yet to check-in and directs them to a check-in desk, screen or other check-in location. In further alternative embodiments, the travel software application 4 may identify that the user has previously checked-in and has indicated that no baggage will be placed in the hold, i.e. the user has no checked-in baggage, in which circumstance the travel software application 4 may direct the user to an alternative location such as, but not limited to, a security desk or queue.

FIG. 15 shows a sixteenth graphical user interface (GUI) 2011 in which the travel software application 4 provides a display area for a notification 2013 directing the traveller to the correct baggage drop location for their flight. The notification 2013 may include live queue status information such as the current waiting time. The display area may also include the time to departure, the time of departure, live flight status information, departure gate status, check-in status, a link to a boarding pass, links to flight searches 2016, check-in software application 2017, contact information 2018, other features of the travel application 2019, and a graphical control element 2012 “Breadcrumbs” of the user interface.

FIG. 15 shows a seventeenth graphical user interface (GUI) 2021 in which the travel software application 4 provides a display area for an airport map 2022. The map application may illustrate the current user location and the location of the baggage drop zones, and a route to the baggage drop queue relevant to the user's flight. The display area may also include live queue status 2023 such as waiting time, and direct the user to the shortest queue.

FIG. 15 shows an eighteenth graphical user interface (GUI) 2031 in which the travel software application 4 provides a display area for a notification 2033 directing the traveller to the correct security checkpoint for their flight. The notification 2033 may include live queue status information such as the current waiting time. The display area may also include the time to departure, the time of departure, live flight status information, departure gate status, check-in status, a link to a boarding pass, links to flight searches 2016, check-in software application 2017, contact information 2018, other features of the travel application 2019, and a graphical control element 2012 “Breadcrumbs” of the user interface.

FIG. 16 shows a nineteenth graphical user interface (GUI) 2041 in which the travel software application 4 provides a display area for an airport map 2042. The map application may illustrate the current user location and the location of the security checkpoint, and a route to the security checkpoint relevant to their flight. The display area may also include live queue status 2043 such as waiting time, and direct the user to the shortest queue.

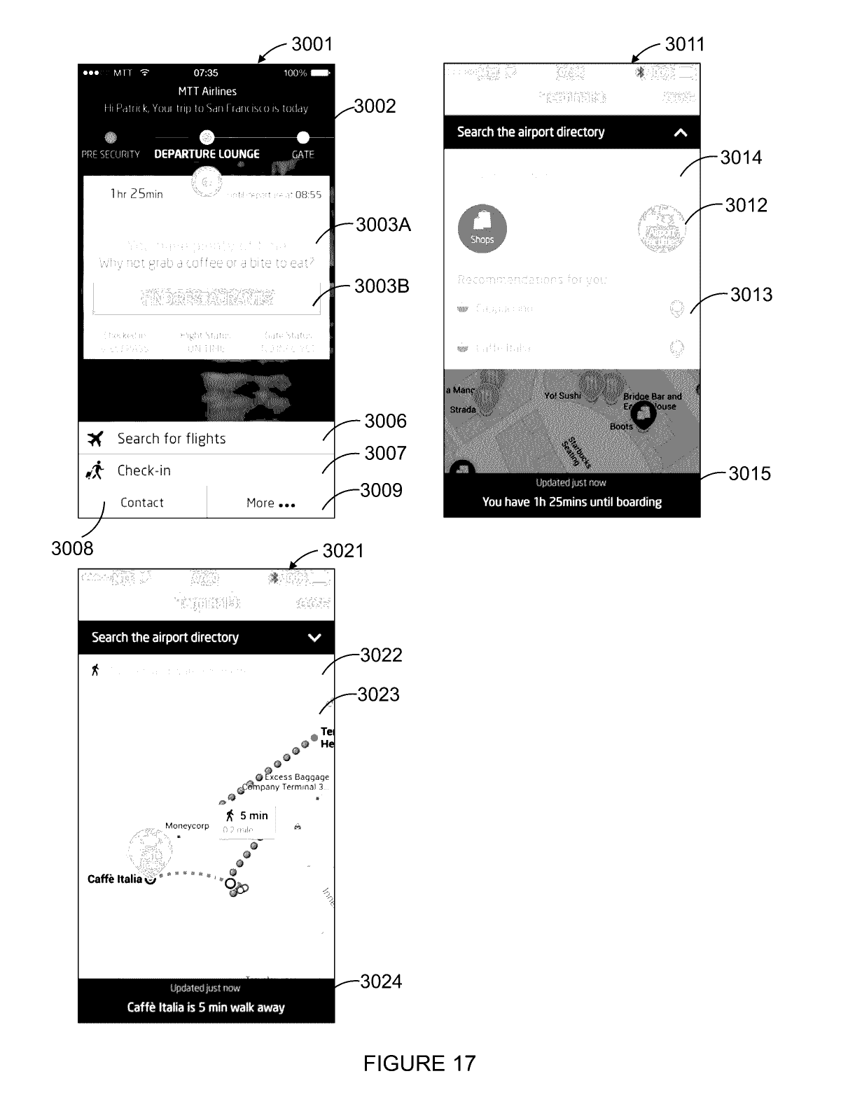

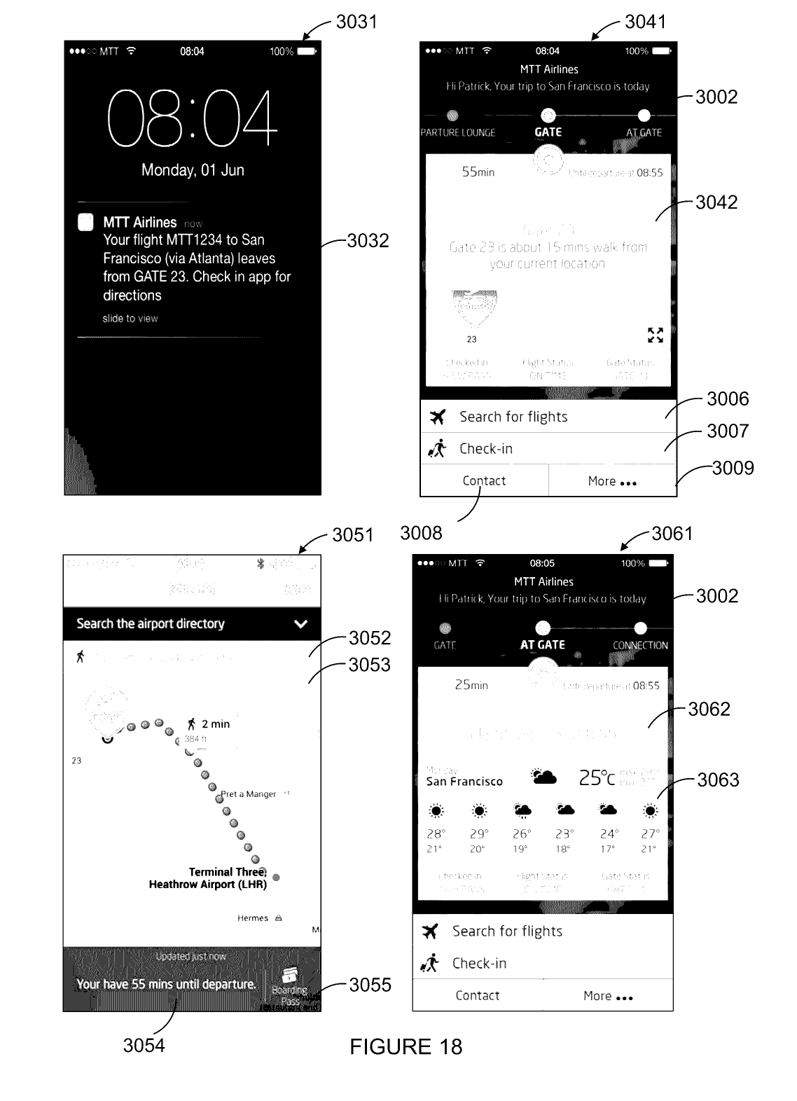

FIGS. 17 and 18 conceptually illustrate exemplary display areas provided by the travel software application 4 which may be displayed when the journey is in the airside state.

The display areas provided in FIG. 17 are optional and may be displayed if the travel software application 4 determines that the traveller has greater than a predefined period of time to wait before it becomes possible or necessary to board the aircraft.

In some embodiments these display screens will not be provided unless the travel software application 4 has determined that the journey is in the airside state and the time to departure (whether the scheduled time of departure or a live updated departure time) is greater than a predefined period of time.

FIG. 17 shows a twentieth graphical user interface (GUI) 3001 in which the travel software application 4 provides a display area for a notification indicating the time until departure of the user's flight. The travel software application 4 may provide a notice 3003A informing the traveller that there is sufficient time before boarding the aircraft in which to take advantage of such airport facilities as may be of interest to them. In the illustrated embodiments the travel software application 4 provides the user with a link 3003B to search for restaurants in the airport. The display area may also include the time to departure, the time of departure, live flight status information, departure gate status, check-in status, a link to a boarding pass, links to flight searches 3006, check-in software application 3007, contact information 3008, other features of the travel application 3009, and a graphical control element 3002 “Breadcrumbs” of the user interface.

FIG. 17 shows a twenty-first graphical user interface (GUI) 3011 in which the travel software application 4 provides a display area for providing search results 3013, a first search feature 3014, a second search feature 3012 and a notice 3015 concerning the current or live time period until boarding commences.

FIG. 17 shows a twenty-second graphical user interface (GUI) 3021 in which the travel software application 4 provides a display area for an airport map 3022. The map application 3022 may illustrate the current user location and the location of the selected airport facility (a coffee shop in the illustrated embodiment), and a route to the selected airport facility. The display area may also include an estimate of the walking time to reach the selected airport facility.

FIG. 18 shows a twenty-third graphical user interface (GUI) 3031 in which the travel software application 4 provides a display area for an alert 3032 informing the user of the relevant departure gate for their flight.

FIG. 18 shows a twenty-fourth graphical user interface (GUI) 3041 in which the travel software application 4 provides a display area for a notification 3042 indicating number of the departure gate and the estimated time to reach the departure gate. The display area may also include the time to departure, the time of departure, live flight status information, departure gate status, check-in status, a link to a boarding pass, links to flight searches 3006, check-in software application 3007, contact information 3008, other features of the travel application 3009, and a graphical element 3002 for control of the user interfaces of the travel software application 4 or for indicating the current journey state. The graphical element 3002 may be in the form of “Breadcrumbs”, a horizontal trail indicating the preceding journey state or user interface and the subsequent journey state or user interface.

FIG. 18 shows a twenty-fifth graphical user interface (GUI) 3051 in which the travel software application 4 provides a display area for an airport map 3053. The display area may illustrate the number of the departure gate of the traveller's flight. The map application 3053 may illustrate the current user location and the location of the departure gate of the traveller flight. The display area may also include a notice 3054 informing the traveller of the period of time before the departure gate closes or until the scheduled, or current live, departure time of the aircraft. The display area may also include a notice 3052 providing navigation instructions. The display area may also include a link 3055 to the boarding pass user interface (see FIG. 11).

FIG. 18 shows an optional twenty-sixth graphical user interface (GUI) 3061 in which the travel software application 4 provides a display area for a notification of the weather conditions. The travel software application 4 may provide weather information relevant to the departure gate or to the destination airport.

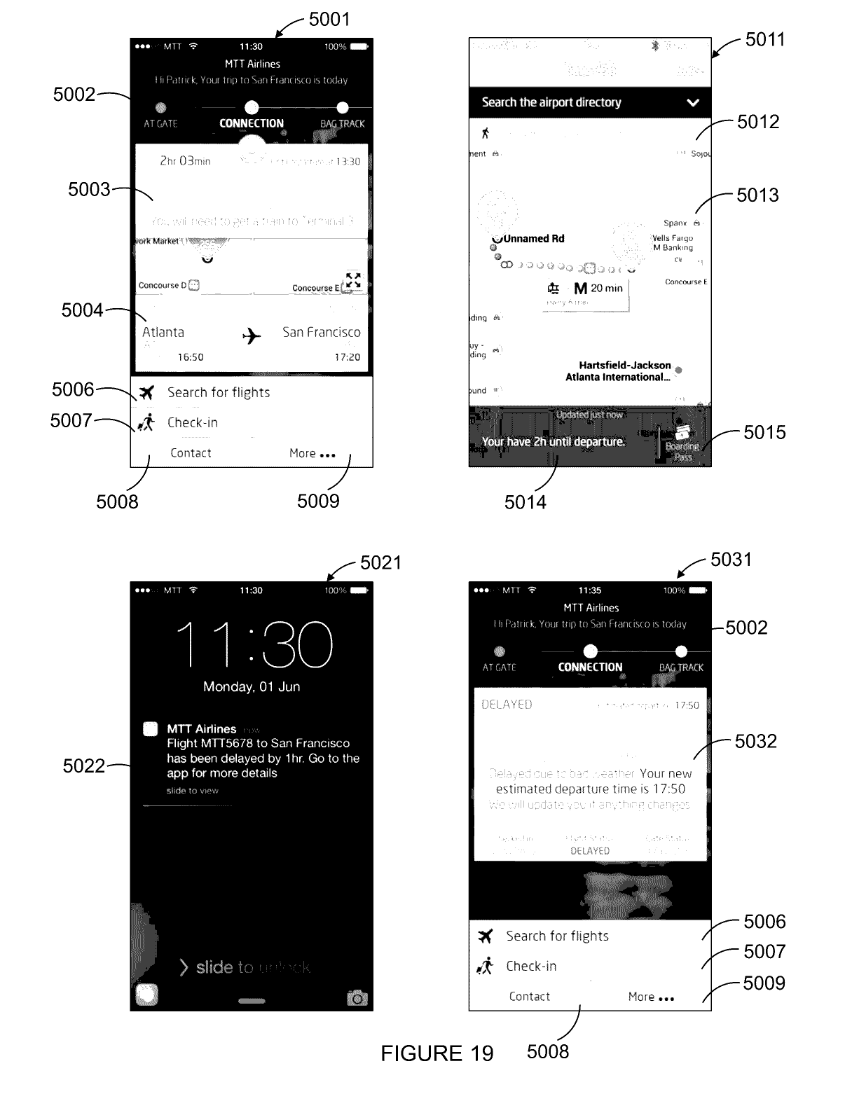

FIG. 19 shows optional graphical user interfaces (GUI) in which the travel software application 4 provides display areas for notifications and/or alerts relevant to a connecting flight forming part of the journey.

A twenty-seventh graphical user interface (GUI) 5001 is shown in which the travel software application 4 provides a display area for a notification 5003 indicating the number of the departure gate and the estimated time to reach the departure gate. The display area may also include the time to departure, the time of departure, live flight status information, departure gate status, check-in status, a link to a boarding pass, links to flight searches 5006, check-in software application 5007, contact information 5008, other features of the travel application 5009, and a graphical element 5002 for control of the user interfaces of the travel software application 4 or for indicating the current journey state. The graphical element 5002 may be in the form of “Breadcrumbs”, a horizontal trail indicating current journey state or user interface along with the preceding journey state or user interface on a first side of the current journey state or user interface and the subsequent journey state or user interface on a second side of the current journey state or user interface.

A twenty-eighth graphical user interface (GUI) 5011 is shown in which the travel software application 4 provides a display area for an airport map 5013. The display area may illustrate the number of the departure gate of the traveller's flight. The map application 5013 may illustrate the current user location and the location of the departure gate of the traveller's flight. The display area may also include a notice 5014 informing the traveller of the period of time before the departure gate closes or until the scheduled, or current live, departure time of the aircraft. The display area may also include a notice 5012 providing navigation instructions. The display area may also include a link 5015 to the boarding pass user interface (see FIG. 11).

A twenty-ninth graphical user interface (GUI) 5021 is shown in FIG. 19 in which the travel software application 4 provides a display area for an alert 5022. The alert informs the traveller that there has been a delay in the traveller's flight, and the length of the delay. The alert 5022 may include instructions to find more information.

A thirtieth graphical user interface (GUI) 5031 is shown in FIG. 19 in which the travel software application 4 provides a display area for a notification 5032 concerning a delay to the traveller's flight. The notification 5032 may include a new estimated departure time, together with reasons or explanations for the delay.

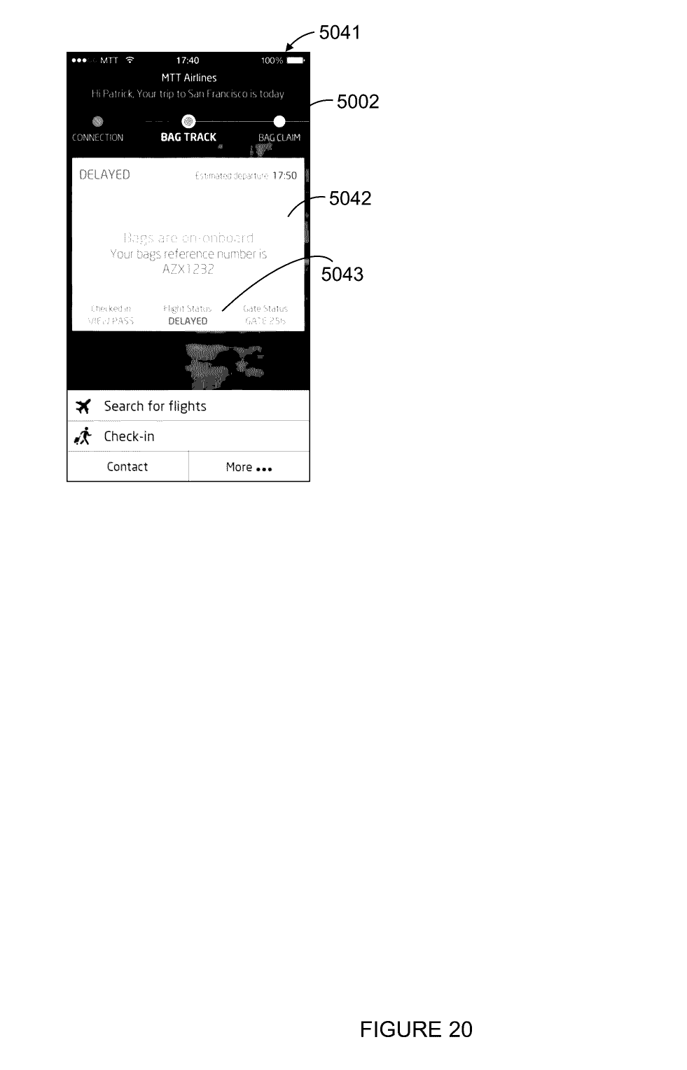

FIG. 20 illustrates a thirty-first graphical user interface (GUI) 5041 in which the travel software application 4 provides a display area for a notification 5042 concerning the location of the traveller's baggage, a tracking or reference number for the baggage and the flight status 5043.

It will be appreciated that GUI 5041 may be displayed in respect of either the initial flight or the connecting flight. Similarly those GUIs 5041 pertaining to delays of the connecting flight may be employed with the initial flight if appropriate circumstances arise in the journey.

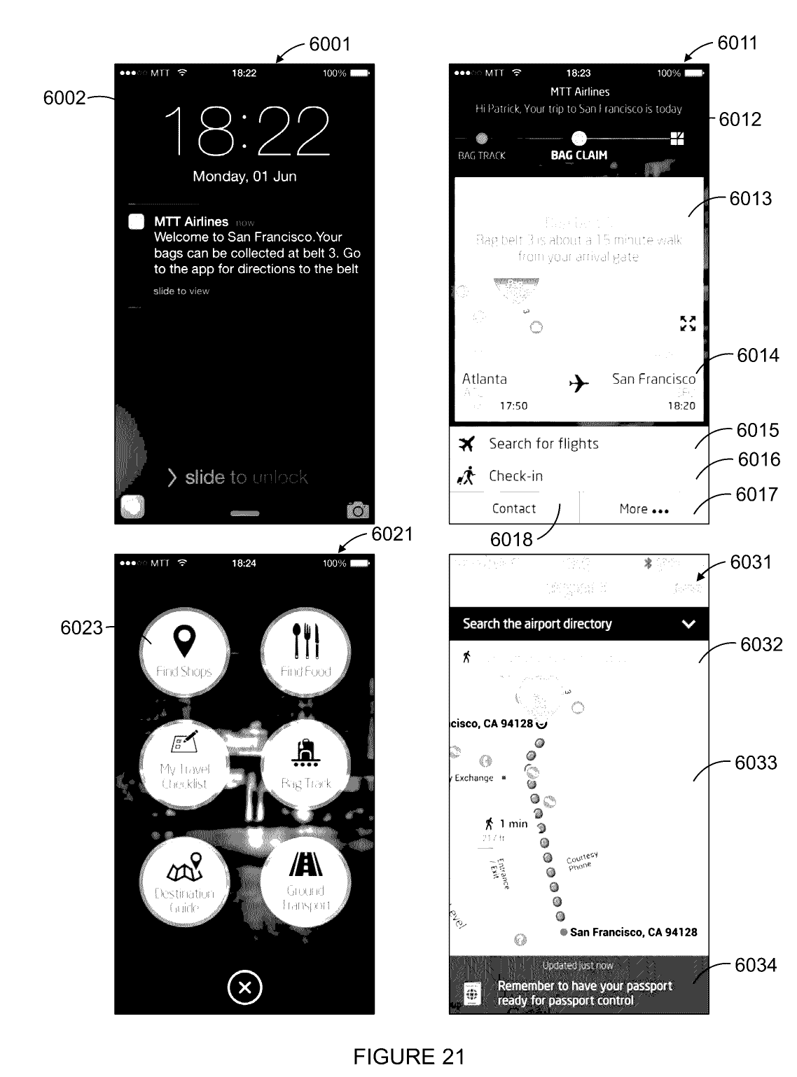

FIG. 21 conceptually illustrates exemplary display areas provided by the travel software application 4 which may be displayed when the journey is in the post-flight state.

FIG. 21 shows a thirty-second graphical user interface (GUI) 6001 in which the travel software application 4 provides a display area for an alert 6002 welcoming the user to the destination airport and informing them of the first location in the airport to which they need to report. In the illustrated embodiment the user is directed to the baggage reclaim belt for their flight. In alternative embodiments, the travel software application 4 may identify that the user has no checked-in baggage, in which circumstance the travel software application 4 may direct the user to an alternative location, for example onward transport facilities such as a taxi queue, a bus stop, a train station or hire car facilities.

FIG. 21 shows a thirty-third graphical user interface (GUI) 6011 in which the travel software application 4 provides a display area for a notification 6013 directing the traveller to the correct baggage claim belt or location for their flight. The display area may also include an estimate of the time required to arrive at the baggage claim belt from the current user location or the arrival gate of the airport.

FIG. 21 shows an optional thirty-fourth graphical user interface (GUI) 6021 in which the travel software application 4 provides a display area for a display to links 6023 to other graphical user interfaces. The travel software application 4 may provide graphical user interface (GUI) 6021 in any of the journey states.

FIG. 21 shows a thirty-fifth graphical user interface (GUI) 6031 in which the travel software application 4 provides a display area for an airport map 6033. The map application 6033 may illustrate the current user location and the location of the baggage claim belt, a route to the baggage claim belt location relevant to the user's flight, and navigation instructions 6032. The display area may also include instructions 6034 regarding the documentation, such as a passport, which will be required to pass through border controls.

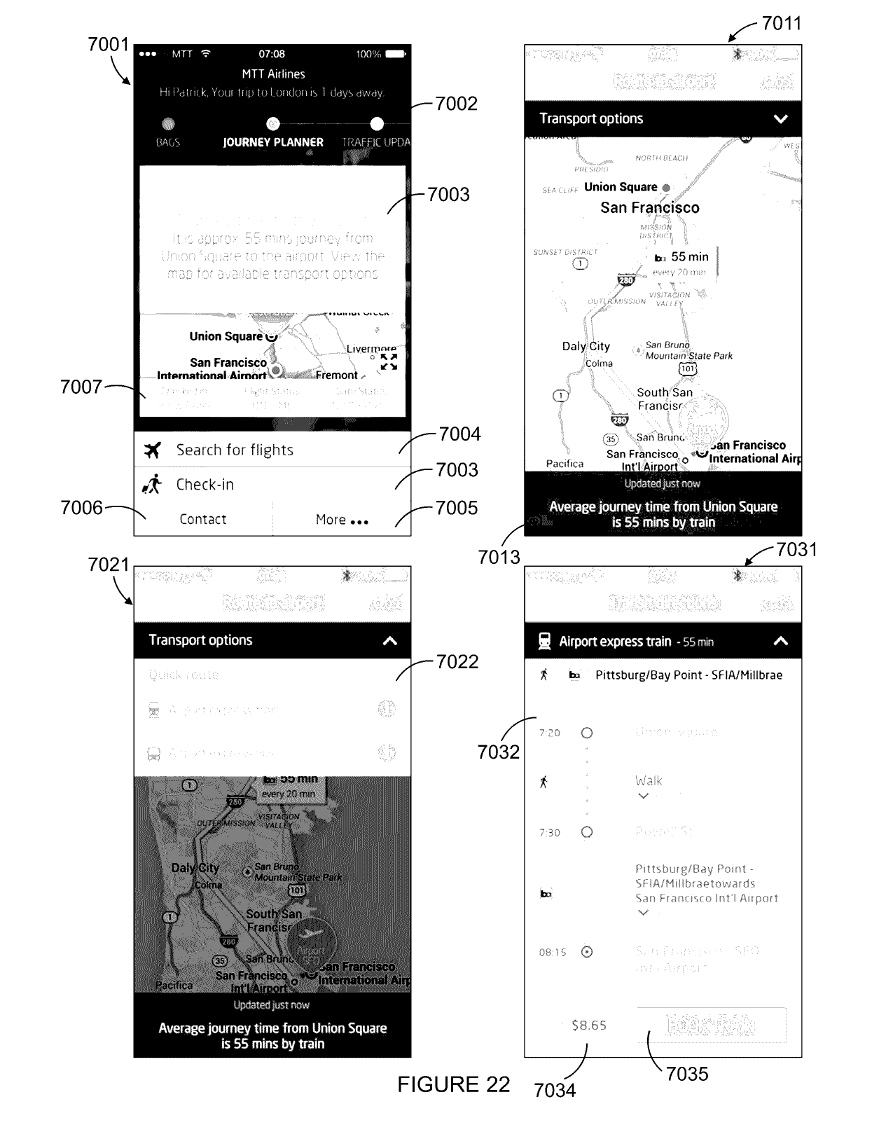

The travel software application 4 may employ any of the graphical user interfaces shown in FIGS. 11 to 21 in respect of a return journey. FIG. 22 conceptually illustrates exemplary graphical user interfaces (GUIs) 7001, 7011, 7021, 7031 provided by the travel software application 4 which may be displayed in respect of a return journey, and show a journey planner to reach the airport by a rail network.

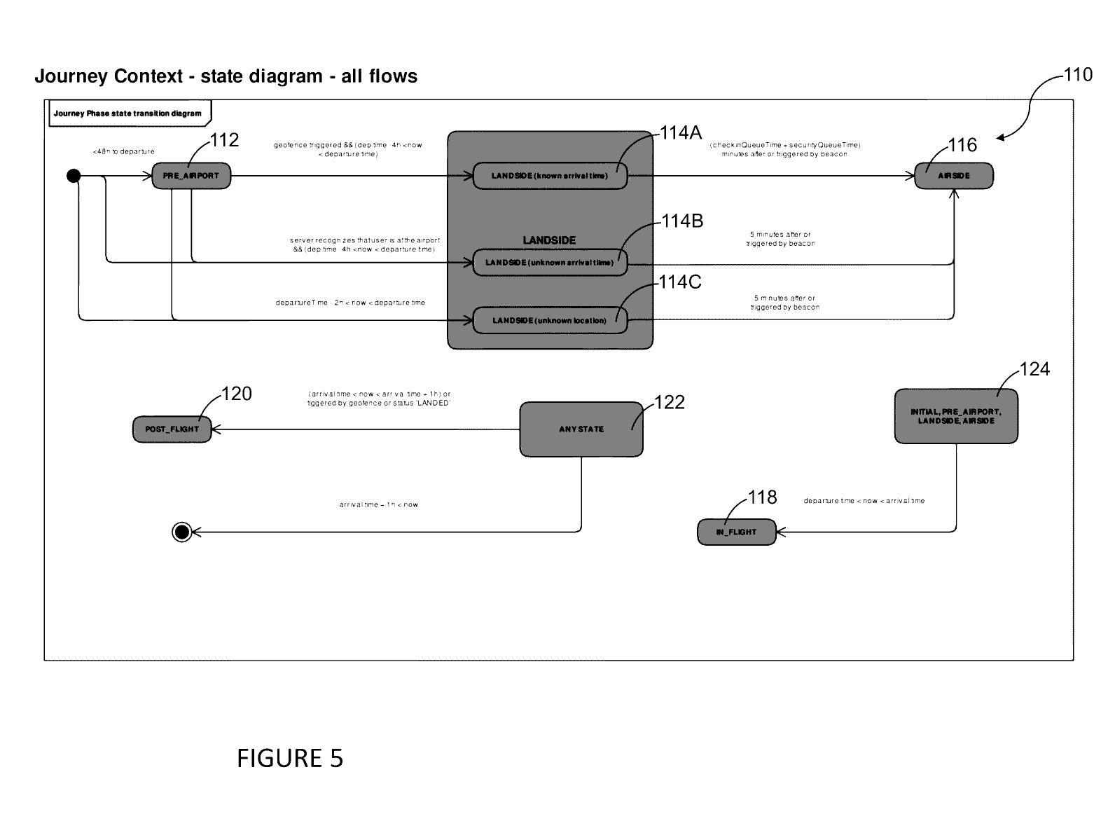

Referring now to FIGS. 5 to 10 alternative embodiments of the present disclosure are illustrated. The additional embodiments share some common features with the embodiment illustrated in FIG. 4 therefore only the differences from the embodiment illustrated in FIG. 4 will be described in detail. In the alternative illustrated embodiments of FIGS. 5 to 10 like numerals have, where possible, been used to denote parts alike to those illustrated in FIG. 4, albeit with the addition of the respective prefix “100”, “200”, “300”, “400”, “500” or “600” to indicate that these features belong to a subsequent embodiment.

FIG. 5 illustrates an embodiment in which the “pre-airport” state 112 commences when the current time is within a predefined period of the departure time. In the illustrated example the travel software application 4 determines that the journey has entered the “pre-airport” journey state 112 and that the current time is less than 48 hours before the departure time.

The travel software application 4 may determine that the journey has entered the landside journey state in one of three methods.

In a first method, the travel software application 4 may determine that the journey has entered the landside journey state 114A if a location-centric criteria is satisfied and, on the condition that the location-centric criteria is satisfied, that a time-centric criteria is also satisfied. The travel software application 4 will not perform the operation to calculate if time-centric criteria is satisfied if the location-centric criteria is not satisfied. The travel software application 4 may receive data indicating that the client device 2 is in the airport from a geolocation or positioning system and on the condition that the current time is between the departure time of flight and a predefined period before the departure time; in the illustrated example the predefined period is 4 hours before departure time. The travel software application 4 will not determine that the journey has entered the landside journey state unless both criteria are satisfied.

In a second method, the travel software application 4 may determine that the journey has entered the landside journey state 114B if a location-centric criteria is satisfied and, on the condition that the location-centric criteria is satisfied, that a time-centric criteria is also satisfied. The travel software application 4 will not perform the operation to calculate if the time-centric criteria is satisfied if the location-centric criteria is not satisfied. The travel software application 4 may receive data indicative of the fact that the client device 2 is in the airport, for example the user checks-in at a check-in desk, screen or location in the airport, or deposits luggage at a baggage drop, and also on the condition that the current time is between the departure time of flight and a predefined period before the departure time. In the illustrated example the predefined period is 4 hours before departure time. The travel software application 4 will not determine that the journey has entered the landside journey state unless both criteria are satisfied.

In a third method, the travel software application 4 may determine that the journey has entered the landside journey state 114C if a time-centric criteria is satisfied. The time-centric criteria is that the current time is between the departure time of the flight and a predefined period before the departure time. In the illustrated example the predefined period is 2 hours before departure time.

The method the travel software application 4 employs to determine that the journey has entered the airside journey state 116 is dependent upon which of the three methods it employed to determine that the journey had entered the landside state.

If the landside state was entered via the first method, the travel software application 4 determines that the journey has entered the airside journey state 116 if a location-centric criteria is satisfied or if a time-centric criteria is satisfied. In order to satisfy the location-centric criteria, the travel software application 4 receives data indicating that the client device 2 is located in the airside of an airport from a geolocation or positioning system. In order to satisfy the location-centric criteria, the travel software application 4 calculates that the time since the landside state was entered is equal to or greater than the sum of the queue time at the check-in desk and the queue time at the security checkpoint.

If the landside state was entered via the second or third methods, the travel software application 4 determines that the journey has entered the airside journey state 116 if a location-centric criteria is satisfied or if a time-centric criteria is satisfied. In order to satisfy the location-centric criteria, the travel software application 4 receives data indicating that the client device 2 is located in the airside of an airport from a geolocation or positioning system. In order to satisfy the location-centric criteria, the travel software application 4 calculates that the time since the landside state was entered is equal to or greater than a predefined time period. In the illustrated example the time period is 5 minutes.

The travel software application 4 may determine that the journey has entered the post-flight state 120 from any of the other journey states 122 by one of two methods.

In a first method, the travel software application 4 may determine that the journey has entered the post-flight state 120 if a location-centric criteria is satisfied or if a time-centric criteria is satisfied. The location-centric criteria may be satisfied if the travel software application 4 receives data indicating that the client device 2 is located in or at the destination airport from a geolocation or positioning system. The location-centric criteria may also be satisfied if the travel software application 4 receives data indicating that the flight has landed from a data source to which it is coupled. The time-centric criteria may be satisfied if the travel software application 4 calculates that the current time is after the arrival time of the flight but not later than a predefined period after the arrival time. In the illustrated embodiment the predefined period is one hour.

In a second method, the travel software application 4 may determine that the journey has entered the post-flight state 120 if a time-centric criteria is satisfied. The time-centric criteria may be satisfied if the travel software application 4 calculates that the current time is later than a predefined period after the arrival time. In the illustrated embodiment the predefined period is one hour.

The travel software application 4 may determine that the journey has entered the in-flight state 118 from the initial, pre-flight, landside or airside states 124 if a time-centric criteria is satisfied. The time-centric criteria may be satisfied if the travel software application 4 calculates that the current time is later than the departure time but not later than the arrival time.

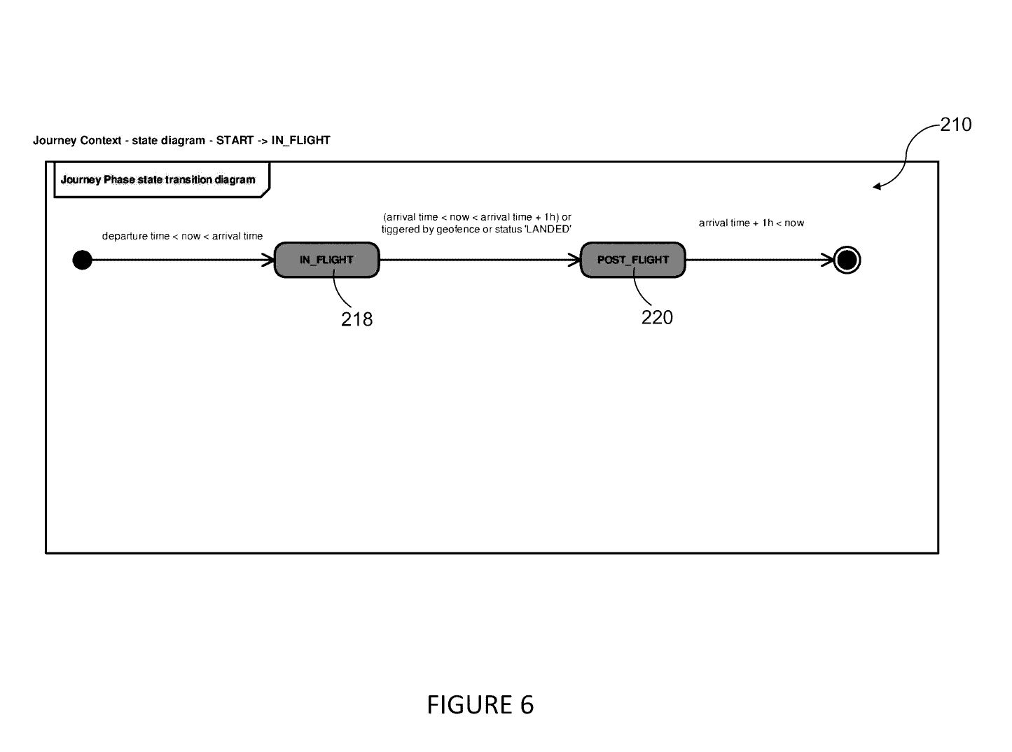

FIG. 6 illustrates an embodiment in which the “pre-airport” state, the landside state and the airside state are omitted. The journey states include: an inflight state 218, and a “post-flight” state 220.

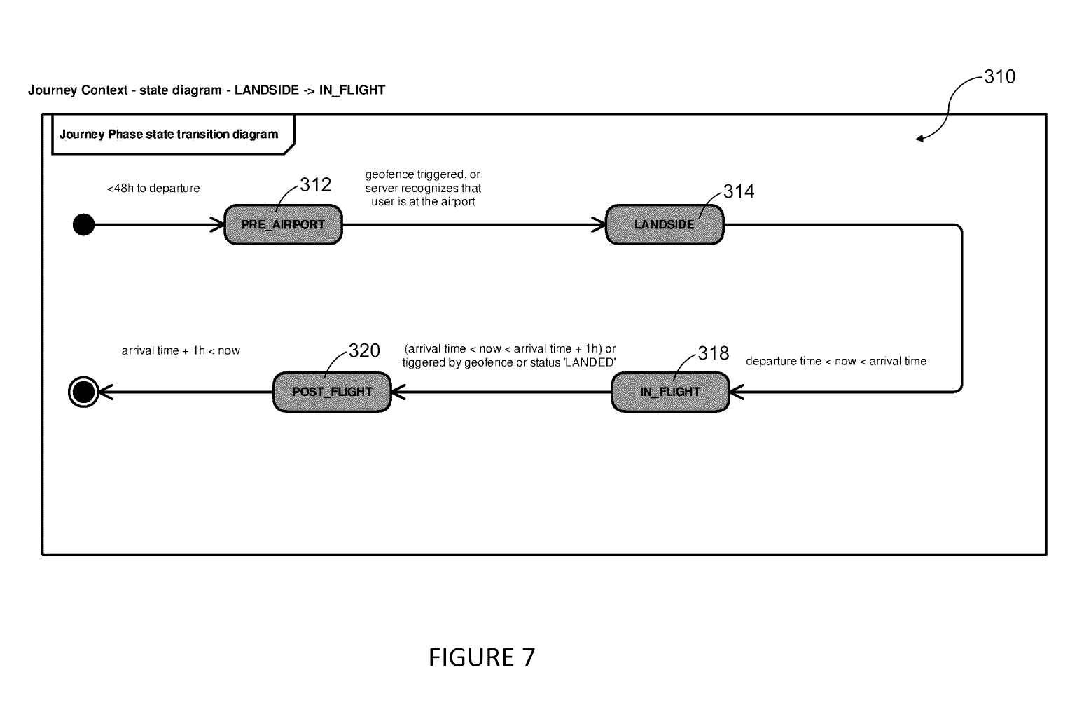

FIG. 7 illustrates an embodiment in which the airside state is omitted. The journey states include: a “pre-airport” state 312, a landside state 314, an inflight state 318 and a “post-flight” state 320.

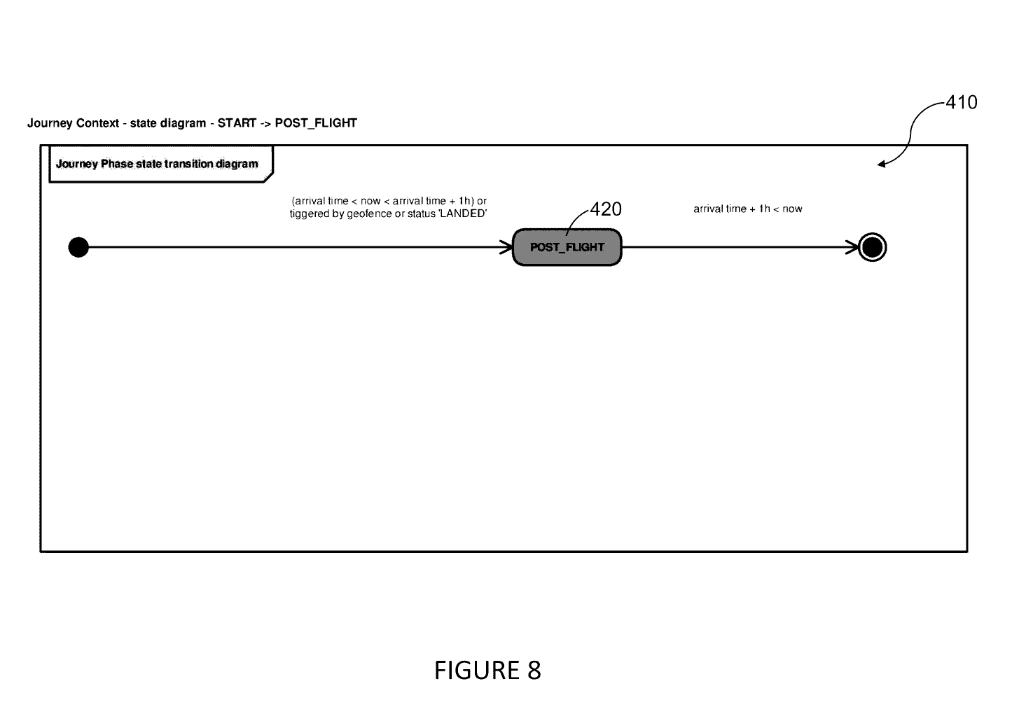

FIG. 8 illustrates an embodiment in which the “pre-airport” state, the landside state, the airside state and the inflight state are omitted. The journey states includes a “post-flight” state 420.

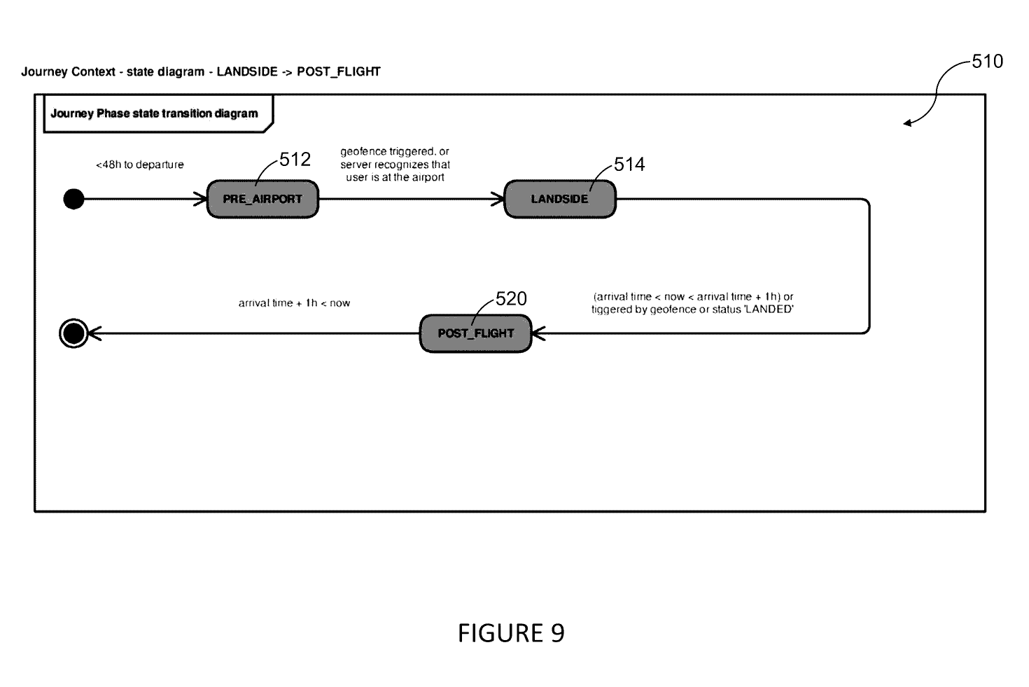

FIG. 9 illustrates an embodiment in which the airside state and inflight state are omitted. The journey states include: a “pre-airport” state 512, a landside state 514, and a “post-flight” state 520.

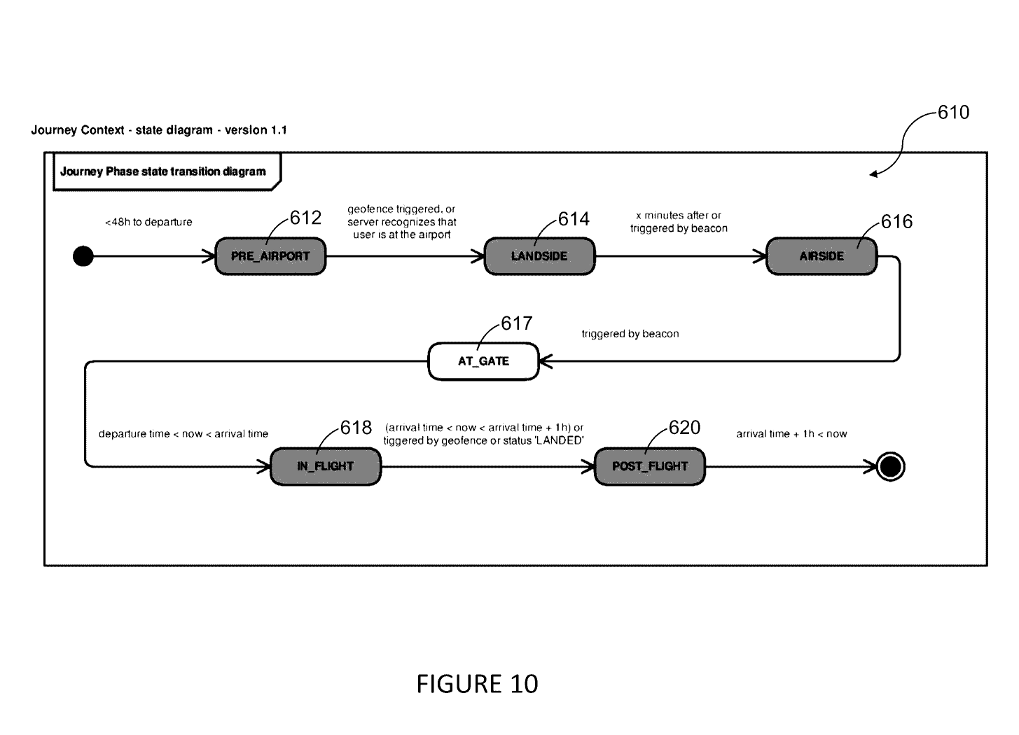

FIG. 10 illustrates an embodiment in which the journey states include an additional “at gate” state 617. The journey states include: a “pre-airport” state 612, a landside state 614, an airside state 616, an “at gate” state 617, an inflight state 618 and a “post-flight” state 620. The “at gate” state 617 precedes the “in-flight” state 618 and follows the airside state 616. The travel software application 4 may determine that the journey has entered the “at gate” state 617 by receiving geolocation or positioning data indicating that the client device 2 is at the gate. The travel software application 4 may determine the “at gate” state 617 has terminated when the “in-flight” state 618 is entered, which may be determined when the current time is between the departure time of the flight and the arrival time of the flight.

It can be appreciated that various changes may be made to the foregoing embodiments within the scope of the present invention. For example the travel application may include graphical user interface in which the travel software application 4 provides a display area for display of advertisements or special offers pertaining to airport facilities.

What is claimed is:

1. A non-transitory machine-readable medium storing a travel application which when executed by at least one processing unit of an apparatus provides a notification dependent upon the current state of a journey, the travel application comprising sets of instructions for:
recording at least one journey;
defining at least one state of the at least one journey;
determining the current state of the at least one journey; and
selecting a notification for display in a display area of a user interface of a device in dependence upon the current state of the at least one journey.

2. The non-transitory machine-readable medium according to claim 1, wherein the set of instructions recording at least one journey includes one or more selected from the following list:
recording data indicative of a travel itinerary;
recording a departure time;
recording a departure location;
recording an arrival time; and
recording a destination location.

3. The non-transitory machine-readable medium according to claim 1, wherein the set of instructions defining the at least one state of the at least one journey includes:
defining at least one time-centric criteria.

4. The non-transitory machine-readable medium according to claim 1, wherein the set of instructions defining the at least one state of the at least one journey includes:
defining at least one location-centric criteria.

5. The non-transitory machine-readable medium according to claim 4, wherein the set of instructions defining at least one time-centric criteria comprises:
a second time-centric criteria which must be satisfied in addition to the location-centric criteria.

6. The non-transitory machine-readable medium according to claim 1, wherein the set of instructions includes:
analysing at least one data source for live travel information relevant to the current state of the journey; and
selecting a notification for display in a display area of a user interface of a device in dependence upon the current state of the at least one journey and the live travel information.

7. A method for providing a user interface of a travel application, the method comprising:
recording at least one journey;
defining at least one state of the at least one journey;
determining the current state of the at least one journey; and
selecting a notification for display in a display area of a user interface of a device in dependence upon the current state of the at least one journey.

8. The method according to claim 7, wherein recording at least one journey comprises one or more selected from the following list:
recording data indicative of a travel itinerary;
recording a departure time;
recording a departure location;
recording an arrival time; and
recording a destination location.

9. The method according to claim 7, wherein defining the at least one state of the at least one journey includes:
defining at least one time-centric criteria.

10. The method according to claim 7, wherein defining the at least one state of the at least one journey includes:
defining at least one location-centric criteria.

11. The method according to claim 10, wherein defining at least one time-centric criteria comprises:
a second time-centric criteria which must be satisfied in addition to the location-centric criteria.

12. The method according to claim 7, wherein the method include:
analysing at least one data source for live travel information relevant to the current state of the journey.

13. A non-transitory machine-readable medium storing an air travel application which when executed by at least one processing unit of an apparatus provides a notification dependent upon the current state of a journey, the travel application comprising sets of instructions for:
recording at least one journey involving air travel;
defining a journey context comprising at least one state based upon a time-centric criteria;
determining the current state of the at least one journey by comparing the current time to the time-centric criteria; and
selecting a notification for display in a display area of a user interface of a device in dependence upon the determined current state of the at least one journey.

14. The non-transitory machine-readable medium according to claim 11, wherein the set of instructions includes:
defining a journey context comprising at least one state based upon a location-centric criteria;
receiving information characteristic of the current location of the device;
determining the current state of the at least one journey by comparing the current location of the device to the location-centric criteria.

15. The non-transitory machine-readable medium according to claim 11, wherein the set of instructions includes:
defining a journey context comprising defining one or more states selected from the following list of states:
a pre-airport state;
a landside state;
an airside state;
an inflight state;
a post-flight state; and
an at gate state.

16. The non-transitory machine-readable medium according to claim 11, wherein the set of instructions includes:
receiving information characteristic of the current location of the device from one or more data sources selected from the following list of data sources:
a geolocation data source;
a positioning data source;
a global positioning system;
a satellite based positioning system;
a Bluetooth based geolocation source;
a wireless based geolocation system;
a Wi-Fi based geolocation system; and
a data entry in a software application indicating the attendance of a traveller at a predefined location on the journey.
